(19) United States
(12) Patent Application Publication
(10) Pub. No.: US 2025/0319998 A1
(43) Pub. Date: Oct. 16, 2025

(54) UNMANNED AERIAL VEHICLE, UNMANNED AERIAL VEHICLE CONTROL SYSTEM, AND UNMANNED AERIAL VEHICLE CONTROL METHOD

(71) Applicant: Kubota Corporation, Osaka-shi (JP)

(72) Inventors: Naohiro ISHIKAWA, Sakai-shi (JP); Takeshi TESHIMA, Sakai-shi (JP)

(21) Appl. No.: 19/248,036

(22) Filed: Jun. 24, 2025

Related U.S. Application Data
(63) Continuation of application No. PCT/JP2022/048156, filed on Dec. 27, 2022.

(51) Int. Cl. B64U 10/60; B64U 10/14; B64U 50/34; G01S 17/933; G05D 1/225; G05D 1/622; G05D 1/672; G05D 101/00; G05D 109/25; G05D 111/10

(52) U.S. Cl. CPC B64U 10/60; B64U 10/14; B64U 50/34; G01S 17/933; G05D 1/225; G05D 1/622; G05D 1/672; G05D 2101/22; G05D 2109/254; G05D 2111/17

(57) ABSTRACT

A control system for controlling a second unmanned aerial vehicle that flies while holding a first cable connected to a first unmanned aerial vehicle that performs work and a second cable extending from a cable reeling machine, includes a sensor to sense a surrounding environment and output sensor data, and a controller configured or programmed to control operation of the unmanned aerial vehicle and, during flight of the second unmanned aerial vehicle, detect the first cable and the second cable based on the sensor data, and upon predicting that at least one of the first cable and the second cable will contact the ground or an obstacle on the ground, change a trajectory of the second unmanned aerial vehicle to avoid the contact.

### CROSS REFERENCE TO RELATED APPLICATIONS

This application is a Continuation Application of PCT Application No. PCT/JP2022/048156 filed on Dec. 27, 2022. The entire contents of this application are hereby incorporated herein by reference.

### BACKGROUND OF THE INVENTION

### 1. Field of the Invention

The present disclosure relates to unmanned aerial vehicles, control systems for unmanned aerial vehicles, and control methods for unmanned aerial vehicles.

### 2. Description of the Related Art

An unmanned aerial vehicle (UAV) is an aircraft that structurally cannot accommodate human occupants and is capable of flight through remote control or autonomous operation. A rotary-wing type unmanned aerial vehicle is a UAV that generates lift using propellers, namely rotary wings, which rotate around an axis. A small unmanned aerial vehicle equipped with multiple rotary wings (Multi-Rotor UAV) is also called a “drone”, “multirotor”, or “multicopter”, and is widely used for applications including aerial photography, surveying, logistics, and agricultural spraying.

Japanese Patent Application Publication No. 2022-104735 describes a system including an agricultural tractor, a first unmanned flying body connected to the tractor by a first cable, and a second unmanned flying body connected to the first unmanned flying body by a second cable. According to Japanese Patent Application Publication No. 2022-104735, power or signals can be supplied from the tractor to the first unmanned flying body and the second unmanned flying body through the first cable and the second cable, allowing the first unmanned flying body and the second unmanned flying body to support the tractor's operations.

### SUMMARY OF THE INVENTION

Example embodiments of the present disclosure provide systems and methods for enhancing the efficiency of operations performed by unmanned aerial vehicles that are supplied with power or signals through cables.

In a non-limiting example embodiment of the present disclosure, a control system for an unmanned aerial vehicle is a control system for a second unmanned aerial vehicle that flies while holding a first cable connected to a first unmanned aerial vehicle performing work and a second cable extending from a cable reeling machine. The control system includes a sensor configured to sense a surrounding environment and output sensor data, and a controller configured or programmed to control the operation of the unmanned aerial vehicle, during flight of the second unmanned aerial vehicle, detect the first cable and the second cable based on the sensor data, and when at least one of the first cable and the second cable is predicted to contact the ground or an obstacle, change a trajectory of the second unmanned aerial vehicle to avoid such contact.

In a non-limiting example embodiment of the present disclosure, a control method for an unmanned aerial vehicle is a control method executed by a computer for controlling a second unmanned aerial vehicle that flies while holding a first cable connected to a first unmanned aerial vehicle performing work and a second cable extending from a cable reeling machine. The control method includes, during flight of the second unmanned aerial vehicle, obtaining sensor data from a sensor that senses the surrounding environment and outputs sensor data, and based on the sensor data, detecting the first cable and the second cable, and when it is predicted that at least one of the first cable and the second cable will contact the ground or an obstacle, changing the trajectory of the second unmanned aerial vehicle to avoid such contact.

According to example embodiments of the present disclosure, it is possible to enhance the efficiency of operations performed by a first unmanned aerial vehicle that is supplied with power or signals through cables.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is a block diagram schematically showing several examples of rotation drivers to rotate rotors in an unmanned aerial vehicle equipped with a plurality of rotors.

FIG. 1B is a plan view schematically showing one example of a basic configuration of an unmanned aerial vehicle equipped with a plurality of rotors.

FIG. 1C is a side view schematically showing one example of a basic configuration of an unmanned aerial vehicle equipped with a plurality of rotors.

FIG. 1D is a plan view schematically showing another example of a basic configuration of an unmanned aerial vehicle equipped with a plurality of rotors.

FIG. 2A is a block diagram showing a basic configuration example of a battery-driven multicopter.

FIG. 2B is a block diagram showing a basic configuration example of a series hybrid drive type multicopter.

FIG. 2C is a block diagram showing a basic configuration example of a parallel hybrid drive type multicopter.

FIG. 3 is a block diagram showing an example of a system configuration according to the present example embodiment of the present invention.

FIG. 4 is a diagram for explaining the operation of the system according to the present example embodiment of the present invention.

FIG. 5 is a diagram showing an example of an operation by the second multicopter to avoid contact between cables and obstacles.

FIG. 6 is a diagram showing another example of an operation by the second multicopter to avoid contact between cables and obstacles.

FIG. 7 is a flowchart showing an example of a process executed by the controller of the second multicopter.

FIG. 8 is a diagram schematically showing the first multicopter flying while performing agricultural work within a work area in a field.

FIG. 9 is a block diagram showing an example of the hardware configuration of the controller of each multicopter.

FIG. 10 is a schematic diagram showing an example of a system configuration including multicopters.

### DETAILED DESCRIPTION OF THE EXAMPLE EMBODIMENTS

Unmanned aerial vehicles include a plurality of rotors and a rotation driver to rotate the rotors (hereinafter referred to as “propellers”). Hereinafter, such an unmanned aerial vehicle is referred to as a “multicopter”.

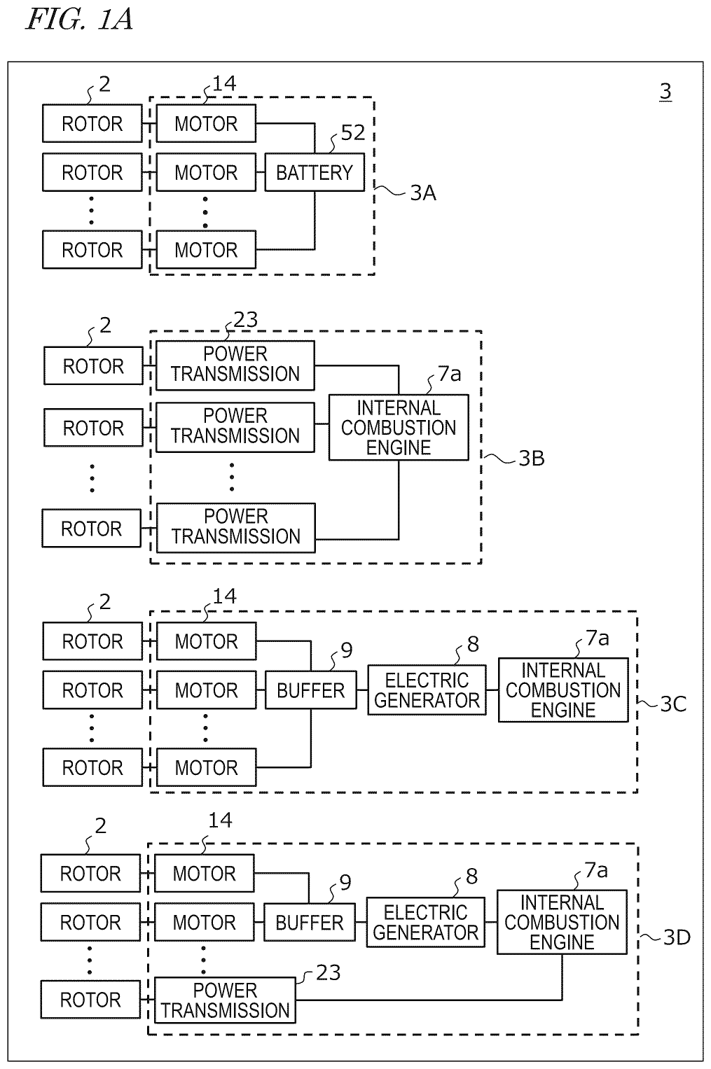

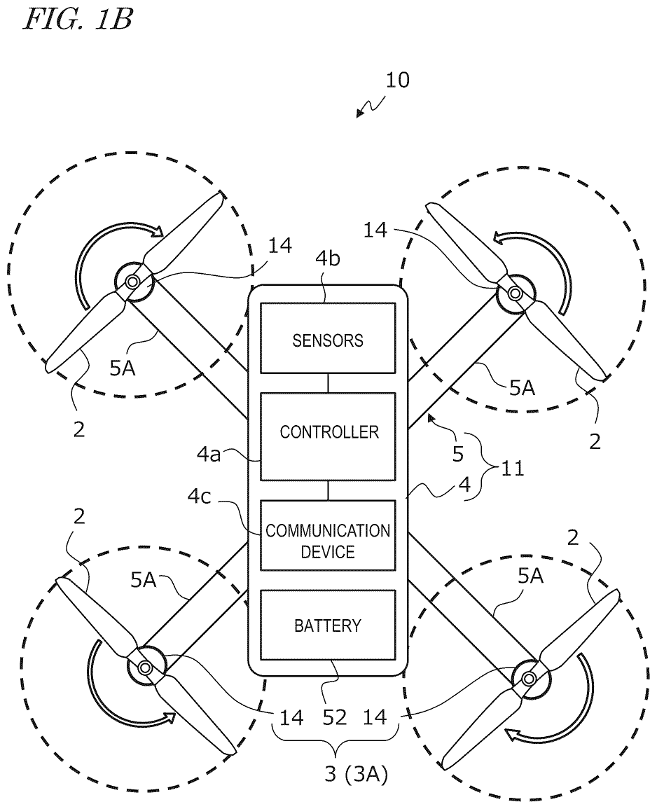

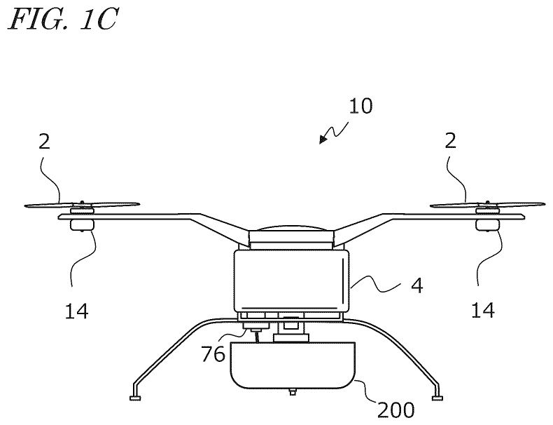

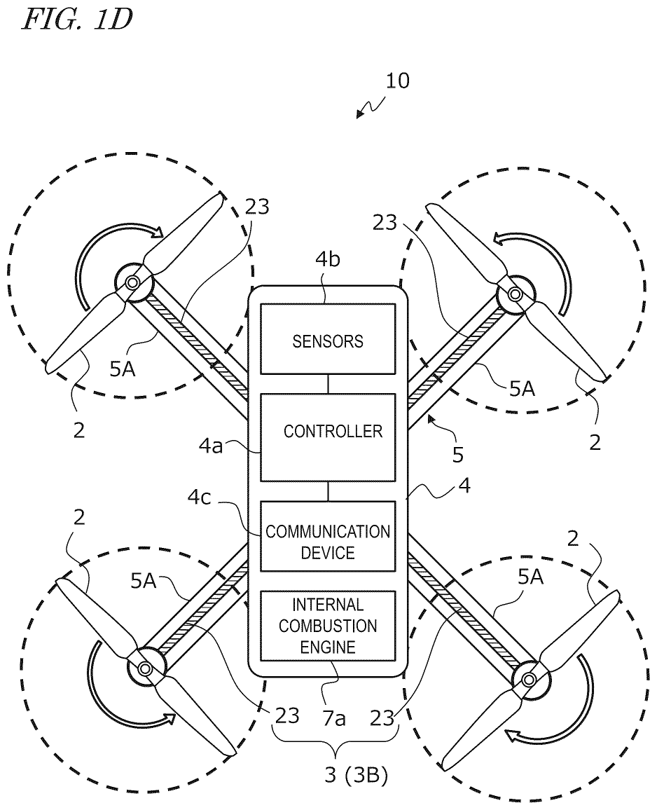

The configuration of rotation drivers equipped in multicopters exists in various forms. FIG. 1A is a schematic block diagram showing four examples of rotation driver 3 according to example embodiments of the present disclosure.

The first rotation driver 3A shown in FIG. 1A includes a plurality of electric motors (hereinafter referred to as “motors”) 14 that rotate a plurality of rotors 2, and a battery 52 that stores electric power to be supplied to each motor 14. The battery 52 is, for example, a secondary battery such as a polymer-type lithium-ion battery. Each rotor 2 is connected to the output shaft of its corresponding motor 14 and is rotated by the motor 14. To increase payload and/or flight duration, it is desirable to increase the power storage capacity of battery 52. While the power storage capacity of battery 52 can be increased by making battery 52 larger, enlarging battery 52 leads to an increase in weight.

The second rotation driver 3B shown in FIG. 1A includes a power transmission system 23 mechanically connected to rotor 2, and an internal combustion engine 7a that provides a driving force (torque) to power transmission system 23. The power transmission system 23 includes mechanical components such as gears or belts and transmits torque from the output shaft of internal combustion engine 7a to rotor 2. The internal combustion engine 7a can efficiently generate mechanical energy through fuel combustion. Examples of internal combustion engine 7a may include gasoline engines, diesel engines, and hydrogen engines. Additionally, the number of internal combustion engines 7a included in rotation driver 3B is not limited to one.

The third rotation driver 3C shown in FIG. 1A includes a plurality of motors 14, a power buffer 9 that stores electric power to be supplied to each motor 14, an electric generator 8 such as an alternator that generates electric power, and an internal combustion engine 7a that provides mechanical energy for power generation to the electric generator 8. While a typical example of power buffer 9 is a battery such as a secondary battery, it may also be a capacitor. In the third rotation driver 3C, even when the power buffer 9 does not have a large power storage capacity, it is possible to increase payload and/or flight duration because the electric generator 8 generates electric power using the driving force (mechanical energy) of internal combustion engine 7a. This type of driver is called a “series hybrid driver”. The electric generator 8 and internal combustion engine 7a in a series hybrid driver are called a “range extender” as they extend the flight distance of the multicopter.

The fourth rotation driver 3D shown in FIG. 1A includes a plurality of motors 14, a power buffer 9 that stores electric power to be supplied to each motor 14, an electric generator 8 such as an alternator that generates electric power, an internal combustion engine 7a that provides a driving force to the electric generator 8 for power generation, a power transmission system 23 that transmits a driving force generated by the internal combustion engine 7a to the rotor 2 to rotate the rotor 2. At least one rotor 2 of the plurality of rotors 2 is rotated by the internal combustion engine 7a, while other rotors 2 are rotated by the motor 14. In the fourth rotation driver 3D, since mechanical energy generated by internal combustion engine 7a can be utilized for rotor rotation without conversion to electrical energy, energy utilization efficiency can be enhanced. This type of driver is called a “parallel hybrid driver”.

FIG. 1B is a plan view schematically showing a basic configuration example of multicopter 10. In the configuration example of FIG. 1B, a rotation driver 3 includes the first rotation driver 3A shown in FIG. 1A. That is, in this example, rotation driver 3 (3A) includes motors 14 and a battery 52. FIG. 1C is a side view schematically showing the multicopter 10.

A multicopter 10 shown in FIGS. 1B and 1C includes a plurality of rotors 2, a main body 4, and a body frame 5 that supports rotors 2 and main body 4. The body frame 5 supports the main body 4 at its central portion and supports the plurality of rotors 2 rotatably at the plurality of arms 5A extending outward from the central portion. The motors 14 that rotate rotors 2 are provided near the ends of each arm 5A. The main body 4 and body frame 5 may be collectively referred to as “body 11”.

In the example of FIG. 1B, the multicopter 10 is a quad-type multicopter (quadcopter) equipped with four rotors 2, for example. The rotors 2 positioned on the same diagonal line rotate in the same direction (clockwise or counterclockwise), while rotors 2 positioned on different diagonal lines rotate in opposite directions.

The main body 4 includes a controller 4a configured or programmed to control the operation of devices and components mounted on multicopter 10, sensors 4b connected to the controller 4a, a communication device 4c connected to the controller 4a, and a battery 52.

The controller 4a may be configured or programmed to include, for example, a flight controller such as a flight controller and a higher-level computer (companion computer). The companion computer may perform advanced computational processing such as image processing, obstacle detection, and obstacle avoidance based on sensor data acquired by the sensors 4b.

The sensors 4b may include an acceleration sensor, angular velocity sensor, geomagnetic sensor, atmospheric pressure sensor, altitude sensor, temperature sensor, flow sensor, imager, laser sensor, ultrasonic sensor, obstacle contact sensor, and GNSS (Global Navigation Satellite System) receiver. The acceleration sensor and angular velocity sensor may be mounted on the main body 4 as components of an IMU (Inertial Measurement Unit). Examples of laser sensors may include a laser range finder used for measuring distance to the ground, and 2D or 3D LiDAR (light detection and ranging).

The communication device 4c may include a wireless communication module for signal transmission and reception with a ground-based transmitter or ground control station (GCS) via an antenna, and a mobile communication module that utilizes cellular communication networks. The communication device 4c is configured or programmed to receive signals such as control commands transmitted from the ground and transmit sensor data such as image data acquired by sensors 4b as telemetry information. The communication device 4c may also include functions for communication between multicopters and satellite communication capabilities. The controller 4a may connect to computers in the cloud through the communication device 4c. The computer in the cloud may execute part or all of the functions of the companion computer.

A battery 52 is a secondary battery that is configured to store electric power through charging and supply electric power to motors 14 through discharging. Through the operation of battery 52 and the plurality of motors 14, a plurality of rotors 2 can be rotationally driven to generate desired thrust.

Each of the plurality of rotors 2 generally includes a plurality of blades with fixed pitch angles and generates thrust through rotation. The pitch angles may be variable. Not all of the plurality of rotors 2 need to have the same diameter (propeller diameter), and one or more rotors 2 may have a larger diameter than other rotors 2. The thrust (static thrust) generated by rotating the rotor 2 is generally proportional to the cube of the rotor's diameter. Therefore, when the rotors 2 of different diameters are equipped, the rotors 2 with relatively large diameters may be called “main rotors” and the rotors 2 with relatively small diameters may be called “sub-rotors”. Regardless of the size of the diameter, the rotors 2 capable of generating relatively large thrust and the rotors 2 capable of generating relatively small thrust may be included depending on the configuration of rotation driver 3. In such case, the rotors 2 capable of generating relatively large thrust may be called “main rotors” and the rotors 2 capable of generating relatively small thrust may be called “sub-rotors”. For example, the rotors 2 that generate relatively large thrust per rotation may be called “main rotors” and the rotors 2 that generate relatively small thrust per rotation may be called “sub-rotors”. In one example, main rotors may be positioned further inward than sub-rotors. In other words, the rotors 2 may be positioned such that the distance from the center of the body to the rotation axis of each main rotor is shorter than the distance from the center to the rotation axis of each sub-rotor.

In this example, the rotation driver 3 includes a plurality of motors 14. As mentioned above, the rotation driver 3 may include the internal combustion engine 7a.

FIG. 1D is a plan view schematically showing a basic configuration example of a multicopter 10 equipped with the second rotation driver 3B. In the example shown in FIG. 1D, the internal combustion engine 7a is supported by the main body 4. In this example, the driving force generated by internal combustion engine 7a is transmitted to the plurality of rotors 2 through a plurality of power transmission systems 23 to rotate each rotor 2. The controller 4a may change the rotational speed of individual rotors 2 by controlling each power transmission system 23. Rotation driver 3B may include a mechanism to change the pitch angle of blades of each of the plurality of rotors 2. In that case, the controller 4a may adjust the lift generated by each rotor 2 by controlling that mechanism to change the blade pitch angles.

In a “parallel hybrid driver” where some of the plurality of rotors 2 are rotated by the internal combustion engine 7a and other rotors 2 are rotated by the motors 14, the internal combustion engine 7a and battery 52 are supported by the main body 4. At least one of the plurality of rotors 2 is connected to the internal combustion engine 7a through the power transmission system 23, and other rotors 2 are connected to the motors 14.

In such a parallel hybrid drive, the diameter of one or more rotors 2 rotated by the internal combustion engine 7a may be larger than the diameter of other rotors 2 rotated by the motors 14. In other words, the internal combustion engine 7a may be used to rotate the main rotors and the motors 14 may be used to rotate the sub-rotors. In such case, the main rotors are mainly used to generate thrust, and the sub-rotors are used for both generating thrust and attitude control. The main rotors may be called “booster rotors” and the sub-rotors may be called “attitude control rotors”.

In the parallel hybrid drive, the internal combustion engine is used for both thrust generation and power generation. By selectively transmitting a driving force (torque) generated by the internal combustion engine to either or both of the rotor and electric generator, it is possible to achieve balanced thrust generation and power generation.

When a multicopter includes an internal combustion engine and uses the internal combustion engine for at least one of thrust generation and power generation, this contributes to increased payload and flight duration. It is desirable to perform attitude control of the multicopter by rotating propellers using motors, which have superior response characteristics compared to internal combustion engines. Therefore, in applications where accurate attitude control of the multicopter is required, it is desirable to adopt a parallel hybrid driver or a series hybrid driver to increase payload and flight duration. Note that when the rotation driver 3 includes a mechanism to change the pitch angle of blades of each of the plurality of the rotors 2, the attitude can also be adjusted by changing the pitch angle of each blade.

Through increased payload and flight duration, the applications of multicopters can be further expanded. For example, in the agricultural field, multicopters are currently being used for agricultural chemical spraying or crop growth monitoring. Various agricultural work can be performed from the air by connecting various ground work machines (hereinafter may be simply referred to as “work machines”) to the multicopter. Agricultural work machines are sometimes referred to as “implements”. Examples of implements may include sprayers for spraying chemicals on crops, mowers, seeders, spreaders (fertilizer applicators), rakes, balers, harvesters, plows, harrows, or rotary tillers. Work vehicles such as tractors are not included in “implements” in this disclosure.

In the example shown in FIG. 1C, an implement 200 capable of dispersing substances such as agricultural chemicals or fertilizers onto a field or crops in the field is connected to multicopter 10. Increased payload and flight duration enable the implement 200 to achieve a larger size and/or multi-functionality. For example, by changing the implement 200 connected to multicopter 10, various ground operations (agricultural work) including liquid application, granular application, fertilization, thinning, weeding, transplanting, direct seeding, and harvesting can be performed. The implement 200 may be equipped with mechanisms such as robotic hands. In that case, a single implement 200 can perform various ground operations. When the implement 200 includes space large enough to store materials, the implement 200 can also transport agricultural materials or harvested crops over a wide area. There are various forms of connecting the implement 200 to the multicopter 10. The multicopter 10 may suspend and tow the implement 200 using a cable. The implement 200 towed by the multicopter 10 can perform ground operations while being towed during flight or hovering of multicopter 10. The implement 200 during operation may be in the air or on the ground.

In the example shown in FIG. 1C, the multicopter 10 includes power supply 76. The power supply 76 supplies power to the implement 200 from driving energy sources such as a battery 52 or an electric generator 8 included in the multicopter 10. Various functions of the implement 200 may be performed using this power. The implement 200 includes actuators such as motors that operate using power obtained from the power supply 76 of the multicopter 10. The implement 200 preferably includes a battery to store power.

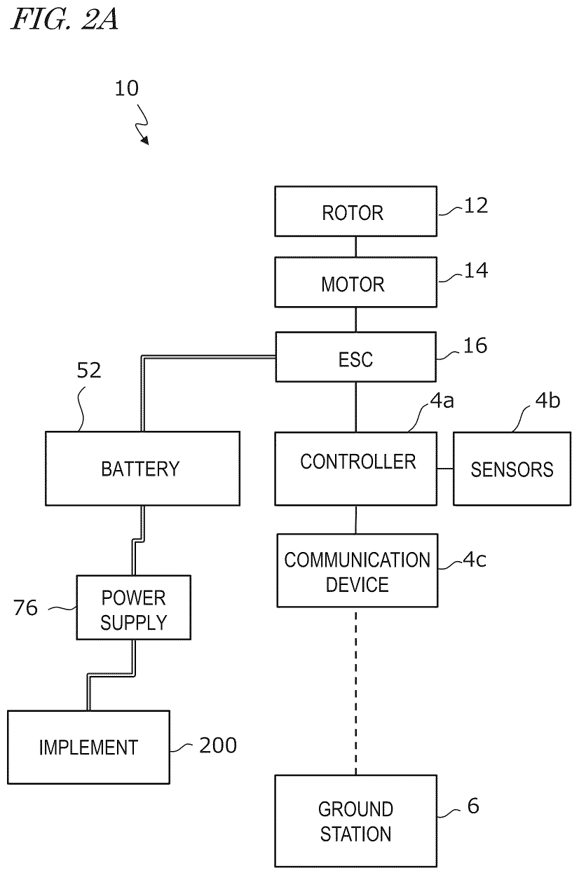

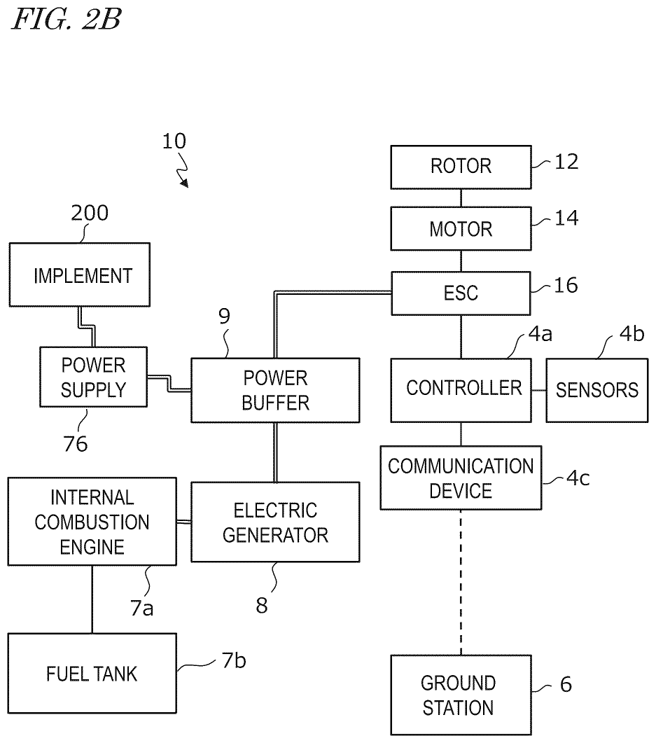

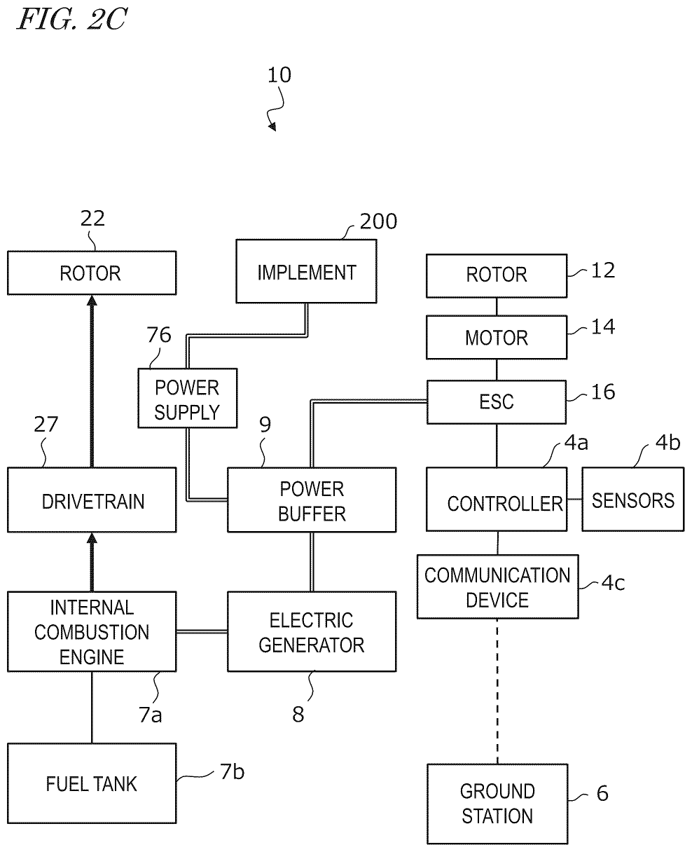

FIG. 2A shows a block diagram of a basic configuration example of a battery-driven multicopter 10. The battery-driven multicopter 10 includes a plurality of rotors 12, a plurality of motors 14, each driving a respective one of the plurality of rotors 12, a plurality of ESCs (Electric Speed Controllers) 16 each including a motor drive circuit that drives a respective one of the plurality of motors 14, a battery 52 that supplies power to each of the plurality of motors 14 through each respective ESC 16, a controller 4a configured or programmed to control a plurality of ESCs 16 to control attitude while flying, sensors 4b, a communication device 4c, and a power supply 76 that is electrically connected to the battery 52. In FIG. 2A, for simplicity, the rotor 12, the motor 14, and the ESC 16 are each shown by a single block, but the numbers of rotors 12, motors 14, and ESCs 16 are each plural. This also applies to FIGS. 2B and 2C. The ESC 16 may be included in the controller 4a.

The controller 4a may receive control commands wirelessly from, for example, a ground station 6 on the ground through the communication device 4c. The number of ground stations 6 is not limited to one, and the grand station 6 may be distributed across a plurality of locations. The communication device 4c may also wirelessly receive control commands from an operator's remote controller on the ground. The controller 4a may have functions to automatically or autonomously execute takeoff, flight, obstacle avoidance, and landing operations based on sensor data obtained from the sensors 4b. The controller 4a may be configured or programmed to communicate with the implement 200 connected to the power supply 76 and obtain signals indicating the state of the implement 200 from the implement 200. Additionally, the controller 4a may provide signals to control the operation of the implement 200. Furthermore, the implement 200 may generate signals to instruct the operation of multicopter 10 and transmit them to the controller 4a. Such communication between the controller 4a and the implement 200 may be conducted through wired or wireless devices or methods.

FIG. 2B is a block diagram showing a basic configuration example of a series hybrid drive type multicopter 10. Like the battery-driven multicopter 10, the series hybrid drive type multicopter 10 includes a plurality of rotors 12, a plurality of motors 14, a plurality of ESCs 16, a controller 4a, sensors 4b, and a communication device 4c. The series hybrid drive type multicopter 10 shown in the figure further includes an internal combustion engine 7a, a fuel tank 7b that stores fuel for the internal combustion engine 7a, an electric generator 8 that is driven by the internal combustion engine 7a to generate electric power, a power buffer 9 that temporarily stores electric power generated by the electric generator 8, and a power supply 76 that is electrically connected to the power buffer 9. The power buffer 9 is, for example, a battery such as a secondary battery. Electric power generated by the electric generator 8 is supplied to the motors 14 through the power buffer 9 and the ESCs 16. Additionally, the electric power generated by the electric generator 8 may be supplied to the implement 200 through the power supply 76.

FIG. 2C is a block diagram showing a basic configuration example of a parallel hybrid drive type multicopter 10. Like the series hybrid drive type multicopter 10, the parallel hybrid drive type multicopter 10 includes a plurality of rotors 12, a plurality of motors 14, each driving a respective one of the plurality of rotors 12, a plurality of ESCs 16, a controller 4a, sensors 4b, a communication device 4c, an internal combustion engine 7a, a fuel tank 7b, an electric generator 8, a power buffer 9, and a power supply 76. The parallel hybrid drive type multicopter 10 further includes a drivetrain 27 that transmits a driving force from the internal combustion engine 7a, and the rotor 22 that rotates upon receiving the driving force from the internal combustion engine 7a through the drivetrain 27. The rotor 12 and rotor 22 may be distinguished by calling one “first rotor” and the other “second rotor”. The number of rotors 22 connected to drivetrain 27 and rotated may be one or two or more.

In the parallel hybrid drive type multicopter 10, the internal combustion engine 7a not only drives the electric generator 8 to generate power, but also mechanically transmits energy to the rotor 22 to rotate the rotor 22. In contrast, in the series hybrid drive type multicopter 10, all rotors 12 are rotated by electric power generated by the electric generator 8. Therefore, in the series hybrid drive type multicopter 10, when the electric generator 8 is, for example, a fuel cell, the internal combustion engine 7a is not an essential component.

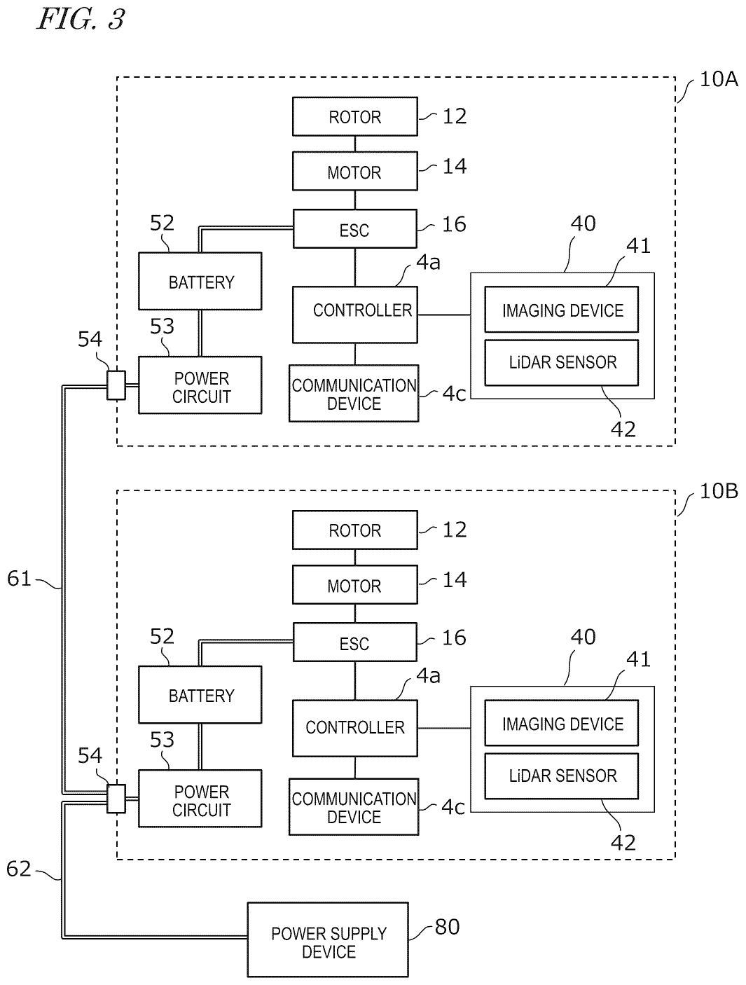

FIG. 3 is a block diagram showing an example of a system configuration according to the present example embodiment. The system shown in FIG. 3 includes a first multicopter 10A (first unmanned aerial vehicle), a second multicopter 10B (second unmanned aerial vehicle), and a power supply device 80. The first multicopter 10A and the second multicopter 10B are connected by a first cable. The second multicopter 10B and the power supply device 80 are connected by a second cable 62.

In the example of FIG. 3, each of the first multicopter 10A and the second multicopter 10B includes components similar to those of the multicopter 10 shown in FIG. 2A. However, the power supply 76 and implement 200 shown in FIG. 2A are omitted from the illustration in FIG. 3. Each multicopter 10A, 10B may be equipped with a connection device for connecting an implement 200 and a power supply 76 for supplying power to the implement 200. In FIG. 3, an imager 41 and a LIDAR sensor 42 are shown as examples of the sensors 4b shown in FIG. 1, and these sensors are collectively called sensor 40.

In FIG. 3, for simplicity, the rotors 12, motors 14, and ESCs 16 in each of the multicopters 10A and 10B are each shown by a single block, but the numbers of rotors 12, motors 14, and ESCs 16 are each plural. Also, although not shown in FIG. 3, the multicopter 10 may be equipped with an internal combustion engine 7a, a fuel tank 7b, and an electric generator 8 as shown in FIG. 2B or FIG. 2C. Furthermore, it may be equipped with at least one rotor 22 driven by an internal combustion engine 7a as shown in FIG. 2C. In that case, either “series hybrid” or “parallel hybrid” drive format may be adopted.

In the example of FIG. 3, each of the first multicopter 10A and the second multicopter 10B further includes a power port 54 and a power circuit 53. The power port 54 receives power supplied from the power supply device 80 through the first cable 61 or the second cable 62 and sends it to the power circuit 53. The power circuit 53 is connected between the power port 53 and the battery 52. The power circuit 53 may include converter circuits that convert the supplied power into direct current power for charging the battery 52.

The first cable 61 is connected to the power port 54 of the first multicopter 10A and the power port 54 of the second multicopter 10B. The second cable 62 is connected to the power port 54 of the second multicopter 10B and the power supply device 80. The power port 54 in the first multicopter 10A functions as a connector to connect the first cable 61. The power port 54 in the second multicopter 10A includes a first connector to connect the first cable 61 and a second connector to connect the second cable 62. The power port 54 may be provided on the housing (for example, the main body 4 shown in FIG. 1A) of each multicopter 10A, 10B. In the power port 54 of the second multicopter 10B, the first connector and the second connector are electrically connected inside the housing.

The power supply device 80 converts power supplied from an external power source into DC or AC power for transmission and outputs it. The power supply device 80 supplies power to the second multicopter 10B through the second cable 62. A portion of this power is also supplied to the first multicopter 10A through the first cable 61. That is, in this example embodiment, the second multicopter 10B is powered through the second cable 62 from the power supply device 80 connected to the second cable 62. On the other hand, the first multicopter 10A is powered from the power supply device 80 through the first cable 61 and the second cable 62.

In the example of FIG. 3, each of the multicopters 10A and 10B includes a control system including a controller 4a and a sensor 40. The sensor 40 senses the surrounding environment and outputs sensor data. The sensor data may include, for example, image data output from the imager 41 or sensor data output from the LiDAR sensor 42. The controller 4a is configured or programmed to control the operation of each multicopter based on the sensor data. This allows the multicopters 10A and 10B to fly in coordination.

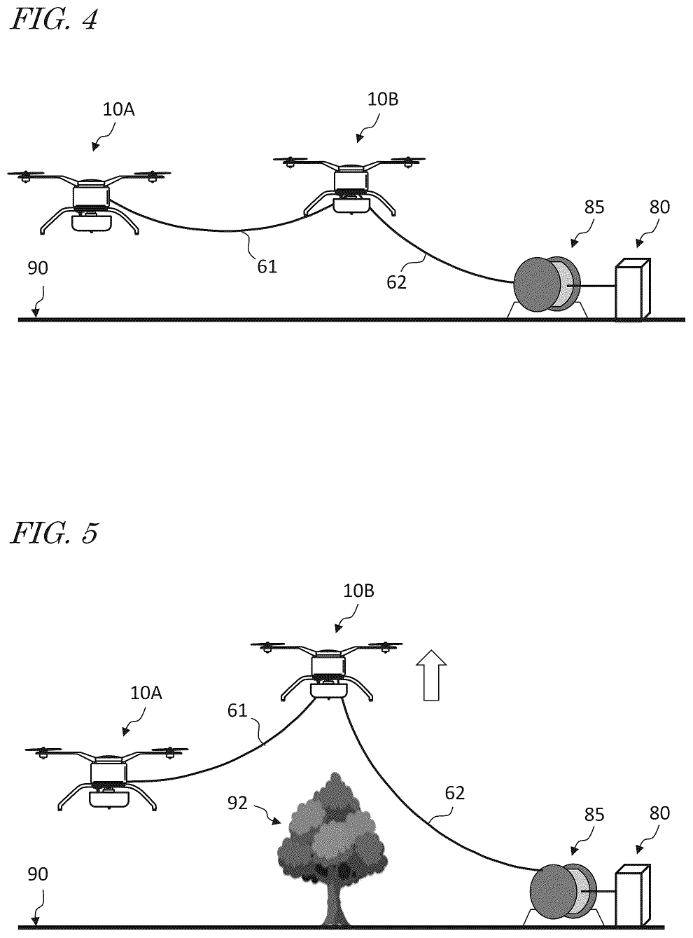

FIG. 4 is a diagram for explaining the operation of the system according to the present example embodiment. In the example of FIG. 4, a power supply device 80 and a cable reeling machine 85 are placed on the ground 90. The cable reeling machine 85 may be an electric or manual cable winding machine. The cable reeling machine 85 can wind or unwind the second cable 62 that connects the second multicopter 10B and the power supply device 80.

In the example of FIG. 4, the first multicopter 10 performs agricultural work such as spraying chemicals above a work area such as a field, and the second multicopter 10B follows the first multicopter 10A and supports the flight and work of the first multicopter 10A. The second multicopter 10B flies while holding the first cable 61 connected to the first multicopter 10A and the second cable extending from the cable reeling machine 85.

In this example embodiment, the first end of the first cable 61 is connected to the first multicopter 10A, and the second end of the first cable 61 and the first end of the second cable 62 are connected to the second multicopter 10B. The second end of the second cable 62 is connected to the power supply device 80 through the cable reeling machine 85. This allows driving power to be supplied by wire from the power supply device 80 to the multicopters 10A and 10B. Since the multicopters 10A and 10B can receive power while flying, long-distance flight is possible without having to land for battery 52 charging.

In this example embodiment, each of the first cable 61 and the second cable 62 includes a power line. One end of the power line in the second cable 62 is connected to the power supply device 80 through the cable reeling machine 85. Each of the first cable 61 and the second cable 62 may include not only a power line but also a communication line. In that case, communication can be conducted between the first multicopter 10A and the second multicopter 10B, and between the second multicopter 10B and the power supply device 80. In such a configuration, the power supply device 80 also serves as a communication device. Alternatively, each of the first cable 61 and the second cable 62 may include only communication lines without power lines. In that case, a communication device would be placed instead of the power supply device 80, and one end of the communication line in the second cable 62 would be connected to the communication device through the cable reeling machine.

During flight of the second multicopter 10B, the controller 4a of the second multicopter 10B executes a process to detect the first cable 61 and the second cable 62 based on sensor data output from the sensor 40 such as the imager 41 or the LiDAR sensor 42. When the controller 4a predicts that at least one of the first cable 61 and the second cable 62 will contact the ground 90 or an obstacle (for example, an obstacle on the ground 90 or in the air), it changes the trajectory of the second multicopter 10B to avoid such contact. This prevents the flight and work of the first multicopter 10A from being hindered by the first cable 61 or the second cable 62 contacting the ground 90 or an obstacle.

As shown in FIG. 3, the sensor 40 may include an imager 41 that outputs time-series image data as sensor data through capturing images. In that case, the controller 4a can predict whether contact will occur based on the time-series image data. Additionally, the sensor 40 may include a LIDAR sensor 42 that outputs time-series point cloud data as sensor data. In that case, the controller 4a can predict whether contact will occur based on the time-series point cloud data. The sensor 40 may include only one of the imager 41 and the LiDAR sensor 42, or it may include both. The controller 4a may detect the ground or obstacles based on both time-series image data and time-series point cloud data. The algorithm for detecting the ground and obstacles from image data or point cloud data is not limited to a specific one. For example, object detection algorithms utilizing deep learning such as CNN (Convolutional Neural Network) can be used.

The controller 4a of the first multicopter 10A can fly the first multicopter 10A along a predetermined target path based on position information output from a positioning device such as a GNSS receiver. Such an operating mode is called an “autonomous operation mode”. The controller 4a of the first multicopter 10A can also operate in a “manual operation mode” that responds to commands from a controller used by a user to fly the multicopter 10A.

The controller 4a of the second multicopter 10A can also operate in autonomous operation mode and manual operation mode. In autonomous operation mode, the controller 4a of the second multicopter 10B flies the second multicopter 10B along a predetermined target path based on position information output from a positioning device such as a GNSS receiver. The controller 4a of the second multicopter 10B can also operate in an “automatic following mode” where it further detects the first multicopter 10A based on sensor data and makes the second multicopter 10B follow the first multicopter 10A based on the detection result of the first multicopter 10A. This allows the second multicopter 10B to automatically follow the first multicopter 10A without piloting the second multicopter 10B. The controller 4a of the second multicopter 10B may be configured to execute operations to avoid contact between cables and the ground or obstacles in autonomous operation mode and automatic following mode. Even in manual operation mode, the controller 4a of the second multicopter 10B may perform operations to avoid contact regardless of commands from the controller if it predicts that cables will contact the ground or obstacles.

FIG. 5 is a diagram showing an example of an operation by the second multicopter to avoid contact between cables and obstacles. In the example of FIG. 5, an obstacle 92 exists near the flight paths of the first multicopter 10A and the second multicopter 10B. In this example, the obstacle 92 is a tree. The obstacle 92 is not limited to trees and may be other objects or people on the ground 90, or birds or other unmanned aerial vehicles in the air.

Here, assume that the first multicopter 10A automatically flies along a predetermined target path, and the second multicopter 10B follows the first multicopter 10A. In the example of FIG. 5, if normal flight control were performed, the first cable 61 and the second cable 62 would contact the obstacle 92, hindering the flight of the first multicopter 10A. Therefore, the controller 4a of the second multicopter 10B determines whether at least one of the first cable 61 and the second cable 62 will contact the obstacle 92 based on sensor data, and if contact is predicted, it changes the trajectory of the second multicopter 10B to avoid such contact. In the example of FIG. 5, the controller 4a avoids contact between cables 61 and 62 and the obstacle 92 by increasing the rotation speed of each rotor to make the second multicopter 10B ascend.

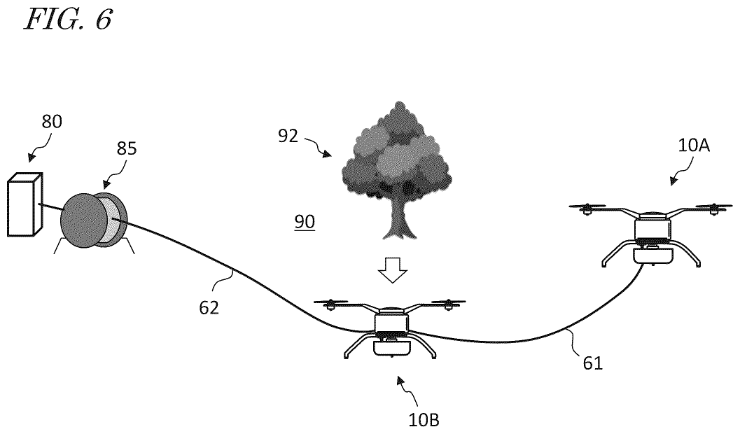

FIG. 6 is a diagram showing another example of an operation by the second multicopter 10B to avoid contact between cables 61 and 62 and the obstacle 92. In the example of FIG. 6, the first multicopter 10A and the second multicopter 10B are flying while maintaining a relatively low altitude. In such cases, the controller 4a of the second multicopter 10B may change the trajectory of the second multicopter 10B to deviate in a direction parallel to the ground 90 to avoid contact between the first cable 61 or the second cable 62 and the obstacle 92.

While FIGS. 5 and 6 both show examples of control to avoid contact between cables 61 and 62 and the obstacle 92, similar control can be used to avoid contact between cables 61 and 62 and the ground 90. Note that each of the multicopters 10A and 10B also has a function to detect and avoid obstacles to prevent itself from contacting obstacles.

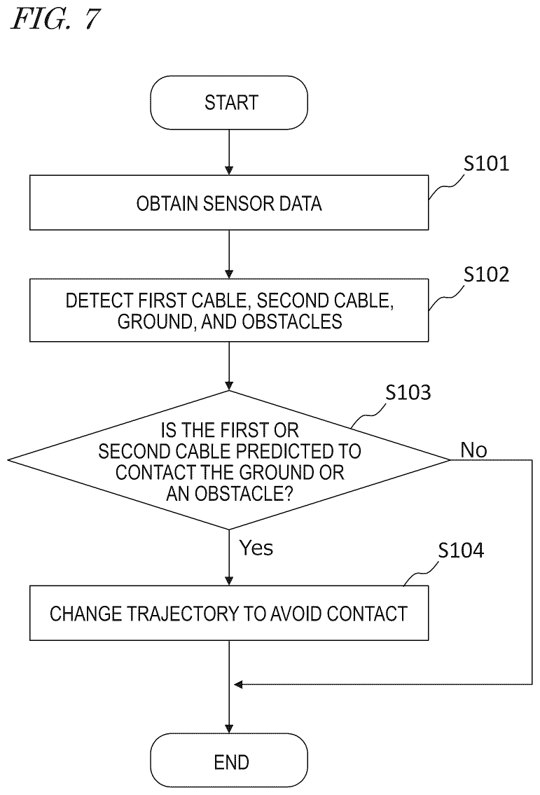

FIG. 7 is a flowchart showing an example of a process executed by the controller 4a of the second multicopter 10B. During flight of the second multicopter 10B, the controller 4a obtains sensor data output from the sensor 40 (step S101). As mentioned earlier, the sensor data may be, for example, time-series image data output from the imager 41 or time-series point cloud data output from the LiDAR sensor 42. Next, the controller 4a detects the first cable, the second cable, the ground, and obstacles based on the obtained sensor data (step S102). Detection may be performed using any object detection algorithm as mentioned earlier. Based on the detection results in step S102, the controller 4a determines whether the first cable 61 or the second cable 62 is predicted to contact the ground or an obstacle (step S103). For example, the controller 4a can detect the movements of the first cable 61, the second cable 62, and obstacles based on time-series image data or point cloud data, and based on those movements, it can predict whether contact will occur within a predetermined time (for example, from a few seconds to about a dozen seconds) if the current flight is continued. If contact is predicted, the controller 4a changes the trajectory of the second multicopter 10B to avoid contact. For example, it changes the trajectory so that cables 61 and 62 move away from the detected ground or obstacle and do not contact other objects. If it is predicted that no contact will occur in step S103, the process of step S104 is not performed, and the current flight control is continued.

The controller 4a repeats the operation shown in FIG. 7 during the flight of the second multicopter 10B. This allows avoiding contact between cables 61 and 62 and the ground or obstacles, enabling smooth execution of flight and work by the first multicopter 10A and the second multicopter 10B.

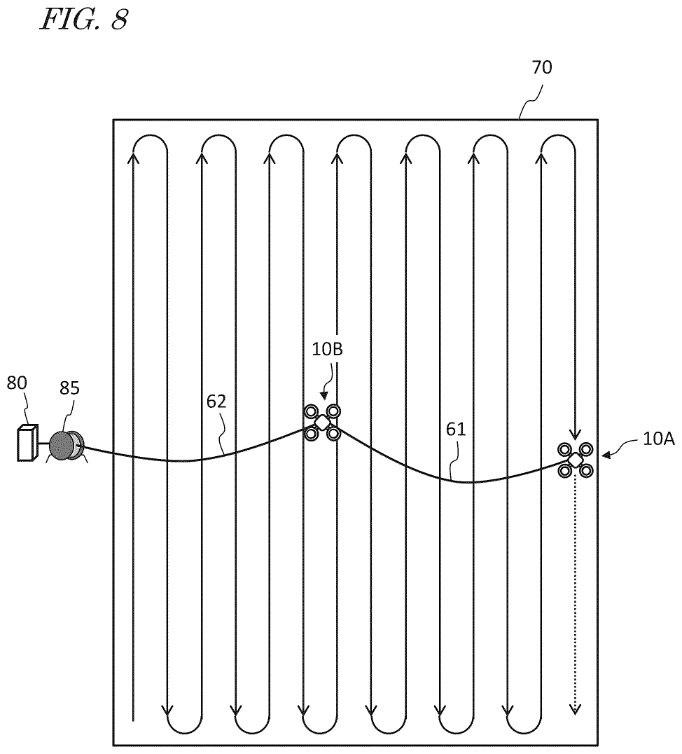

Next, an example of agricultural work operation by the first multicopter 10A and the second multicopter 10B will be explained with reference to FIG. 8.

FIG. 8 is a diagram schematically showing the first multicopter 10A flying while performing agricultural work within a work area 70 in a field. In FIG. 8, the arrow line shown within the work area 70 schematically indicates the flight path that the first multicopter 10A has passed through by autonomous operation mode. In autonomous operation mode, the first multicopter 10A is controlled to fly along a predetermined target path. In autonomous operation mode, the controller 4a of the first multicopter 10A flies the first multicopter 10A along the target path based on the position of the first multicopter 10A measured by the GNSS receiver and the target path set above the work area 70. The target path may be predetermined by a user, and its information is recorded in the storage device 4e. The user can set the work area 70 and the target path through operations using a GUI (Graphical User Interface) that includes a map of the field displayed on a setting information terminal.

In the example of FIG. 8, a power supply device 80 and a cable reeling machine 85 are installed on the ground surrounding the work area 70. The first multicopter 10A and the second multicopter 10B are connected by the first cable 61. The second multicopter 10B and the power supply device 80 are connected by the second cable 62 through the cable reeling machine 85. While the first multicopter 10A performs agricultural work while flying along the target path, the second multicopter 10B holds cables 61 and 62 while adjusting its position so that cables 61 and 62 do not contact the ground or obstacles. This prevents the flight and work of the first multicopter 10A from being hindered by contact between cables 61 and 62 and the ground or obstacles, and prevents crops in the work area 70 from being damaged by cables 61 and 62.

In this example, only the first multicopter 10A performs agricultural work, but the second multicopter 10B may also perform agricultural work while holding cables 61 and 62. The work can also be made more efficient by having the second multicopter 10B work in coordination with the first multicopter 10A.

The work performed by multicopters 10A and 10B is not limited to examples such as shown in FIG. 8 and may be work performed over a wide area including multiple fields, such as supplying and transporting agricultural materials, transporting harvested crops, monitoring crop growth conditions, surveying, and map creation. When multicopters 10A and 10B transport agricultural materials or harvested crops, for example, they may fly automatically or autonomously, or by remote control, over areas outside fields (including areas with forests, rivers, etc.).

In this example embodiment, the first cable 61 and the second cable 62 are two independent cables, but the first cable 61 and the second cable 62 may be different portions of a single cable. That is, the first cable 61 may be the portion of a single cable between one end connected to the first multicopter 10A and the position held by the second multicopter 10B. Also, the second cable 62 may be the portion of that single cable between the position stored in the cable reeling machine and the position held by the second multicopter 10B. In that case, the single cable may not be connected to the second multicopter 10B, and the second multicopter 10B may simply hold the intermediate position of the single cable by a mechanism such as suspending.

Also, in this example embodiment, two unmanned aerial vehicles (multicopters 10A and 10B) operate in coordination, but three or more unmanned aerial vehicles may operate in coordination. In that case, two or more unmanned aerial vehicles may hold cables connected to other unmanned aerial vehicles, similar to the second multicopter 10B in this example embodiment, and perform control to avoid contact between cables and the ground or obstacles.

The controller 4a in each of the multicopters 10A and 10B according to the example embodiment of the present disclosure may be realized by a digital computer system configured or programmed to execute the aforementioned processes.

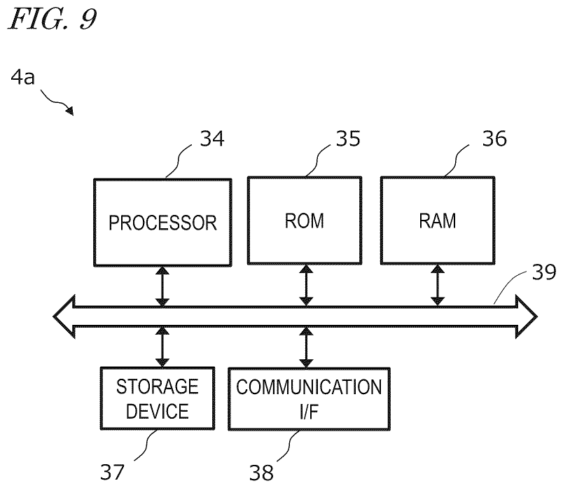

FIG. 9 is a block diagram showing an example of the hardware configuration of the controller 4a. The controller 4a may include a processor 34, ROM (Read Only Memory) 35, RAM (Random Access Memory) 36, storage device 37, and communication I/F 38. These components are interconnected via a bus 39.

The processor 34 may include one or more semiconductor integrated circuits, also referred to as a central processing unit (CPU) or microprocessor. The processor 34 sequentially executes computer programs stored in ROM 35 to implement the aforementioned processing. The processor 34 is broadly interpreted to include terms such as FPGA (Field Programmable Gate Array) with CPU, GPU (Graphic Processor Unit), ASIC (Application Specific Integrated Circuit), or ASSP (Application Specific Standard Product).

The ROM 35 is, for example, a writable memory (for example, PROM), rewritable memory (for example, flash memory), or read-only memory. The ROM 35 stores programs that control the operation of the processor. The ROM 35 need not be a single recording medium but may be a collection of multiple recording media. Part of the multiple media collection may be removable memory.

The RAM 36 provides a work area for temporarily expanding programs stored in the ROM 35 during boot-up. The RAM 36 need not be a single recording medium but may be a collection of multiple recording media.

The communication I/F 38 is an interface for communication between the controller 4a and other electronic components or electronic control units (ECUs). For example, the communication I/F 38 may perform wired communication complying with various protocols. The communication I/F 38 may perform wireless communication complying with Bluetooth® standards and/or Wi-Fi® standards. Both standards include wireless communication standards utilizing the 2.4 GHz frequency band.

The storage device 37 may be, for example, a semiconductor memory, magnetic storage device, or optical storage device, or a combination thereof. The storage device 37 can store, for example, map data useful for autonomous flight of the multicopter 10, and various sensor data acquired by the multicopter 10 during flight.

It should be noted that, as mentioned earlier, the controller 4a may be configured or programmed to include, for example, a flight controller such as a flight controller and a higher-level computer (companion computer). The companion computer may execute each of the aforementioned processes and provide flight-related commands to the flight controller based on the results of those processes.

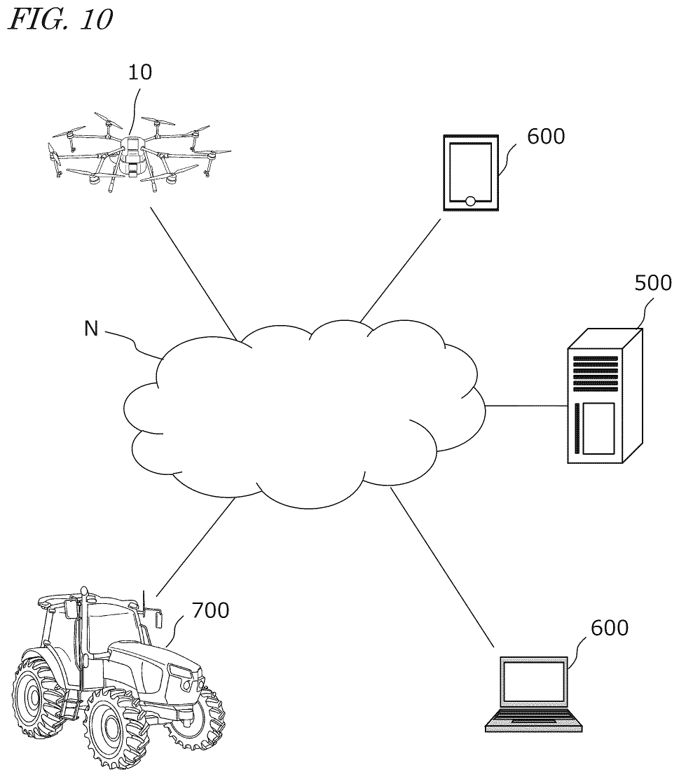

FIG. 10 is a schematic diagram showing an example of a system configuration including multicopters 10. Some or all of the functions of the controller 4a may be implemented by one or more servers (computers) 500 or terminal devices (including portable and fixed types) 600 connected to the communication device 4c of the multicopter 10 via a communication network N. Agricultural machines 700 such as tractors may be connected to this communication network N, and communication may take place between the multicopter 10 and agricultural machines 700. Some of the data used for processing by the controller 4a and control signals for the multicopter 10 may be provided to the multicopter 10 from agricultural machines 700 through the communication network N.

Systems providing various functions in the above example embodiments can also be attached later to multicopters that do not have those functions. Such systems can be manufactured and sold independently of multicopters. Computer programs used in such systems can also be manufactured and sold independently of multicopters. Computer programs may be provided, for example, stored on computer-readable non-transient storage media. Computer programs may also be provided through downloading via telecommunications lines (for example, the Internet).

As described above, the present disclosure includes control systems, control methods, and unmanned aerial vehicles described in the following items.

Unmanned aerial vehicles according to example embodiments of the present disclosure may be widely utilized not only for applications such as aerial photography, surveying, logistics, and agricultural spraying, but also for ground work related to agricultural work, and transportation of harvested crops and agricultural materials.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A control system for a second unmanned aerial vehicle configured to fly while holding a first cable connected to a first unmanned aerial vehicle configured to perform work and a second cable extending from a cable reeling machine, the control system comprising:
a sensor configured to sense a surrounding environment and output sensor data; and
a controller configured or programmed to:
control operation of the unmanned aerial vehicle;
detect the first cable and the second cable based on the sensor data during flight of the second unmanned aerial vehicle; and
upon predicting that at least one of the first cable and the second cable will contact the ground or an obstacle, change a trajectory of the second unmanned aerial vehicle to avoid the contact.

2. The control system according to claim 1, wherein
the sensor includes an imager configured to output time-series image data as the sensor data through capturing images; and
the controller is configured or programmed to predict whether contact will occur based on the time-series image data.

3. The control system according to claim 1, wherein
the sensor includes a LIDAR sensor configured to output time-series point cloud data as the sensor data; and
the controller is configured or programmed to predict whether contact will occur based on the time-series point cloud data.

4. The control system according to claim 1, wherein the controller is configured or programmed to:
further detect the first unmanned aerial vehicle based on the sensor data; and
upon detecting the first unmanned aerial vehicle, cause the second unmanned aerial vehicle to follow the first unmanned aerial vehicle.

5. The control system according to claim 1, wherein
each of the first cable and the second cable includes a power line; and
one end of the power line in the second cable is connected to a power supply device through the cable reeling machine.

6. The control system according to claim 1, wherein
each of the first cable and the second cable includes a communication line; and
one end of the communication line in the second cable is connected to a communication device through the cable reeling machine.

7. The control system according to claim 1, wherein
each of the first cable and the second cable is a different portion of a single cable;
the first cable is a portion of the single cable between one end connected to the first unmanned aerial vehicle and a position held by the second unmanned aerial vehicle, and
the second cable is a portion of the single cable between a position stored in the cable reeling machine and the position held by the second unmanned aerial vehicle.

8. The control system according to claim 1, wherein
the second unmanned aerial vehicle includes a housing including a first connector to connect the first cable and a second connector to connect the second cable, and
the first connector and the second connector are electrically connected inside the housing.

9. The control system according to claim 8, wherein
the second unmanned aerial vehicle is configured to be powered through the second cable from a power supply device that is connected to the second cable; and
the first unmanned aerial vehicle is configured to be powered through the first cable and the second cable from the power supply device.

10. An unmanned aerial vehicle comprising:
the control system according to claim 1; and
a plurality of rotors configured to be controlled by the control system.

11. A control method executed by a computer that controls a second unmanned aerial vehicle configured to fly while holding a first cable connected to a first unmanned aerial vehicle configured to perform work and a second cable extending from a cable reeling machine, the control method comprising, during flight of the second unmanned aerial vehicle:
obtaining sensor data from a sensor configured to sense a surrounding environment and output sensor data;
detecting the first cable and the second cable based on the sensor data; and
upon predicting that at least one of the first cable and the second cable will contact the ground or an obstacle, changing a trajectory of the second unmanned aerial vehicle to avoid the contact.
